(19) United States
(12) Patent Application Publication
(10) Pub. No.: US 2014/0047864 A1
(43) Pub. Date: Feb. 20, 2014

(54) FLEXIBLE WEARABLE BANDS

(71) Applicants: Yung-Cheng Lo, Cupertino, CA (US); Yung-Fen Lo, Oakland, CA (US); Ching-Fu Lo, Oakland, CA (US)

(72) Inventors: Yung-Cheng Lo, Cupertino, CA (US); Yung-Fen Lo, Oakland, CA (US); Ching-Fu Lo, Oakland, CA (US)

(73) Assignee: Whatino Inc.

(21) Appl. No.: 13/589,902

(22) Filed: Aug. 20, 2012

(51) Int. Cl. F16B 2/00; A44C 5/00

(52) U.S. Cl. 63/3.1; 24/481; 24/464

(57) ABSTRACT

In one embodiment, the application discloses a connecting assembly for connecting a wearable band comprising at least one connector body, at least one linker, at least one slot, wherein the slot is configured on the connector body or configured on the linker; wherein the linker is configured to accept the protrusion to reversibly connect the linker to the connector body; and wherein the linker and the connector body comprise of material selected from silicone or a silicone composite. The connecting assembly may be used to carry or store personal and safety or security items.

### BACKGROUND OF THE INVENTION

Bands and bracelets are usually made from one continuous piece of material which can be a single solid band or a chain of interlocking rings with open ends that are closed by clasp or other small, complicated connecting structure, i.e., a connector. The existing designs for commercially available connectors are uniformly unimaginative in their shape, forms and compositions. The connector can be a fastener, a hook and an eye or a snap that can only be joined by troublesome fastening or unfastening. Additionally, the connector is often very small and has a complicated structure. If the connector breaks, remedial options can be a complete and expensive replacement involving a jewelry repairperson or discarding the band or bracelet due to the cost of the repair. Currently available band or bracelet also comes in fixed length and produces a fixed diameter. The wearer must permanently cut a segment of oversize band or bracelet to fit the wearer's own comfortable size. Further, no connector currently exist that allows the wearer to easily close the band or bracelet, while expressing or displaying a personal taste, such as a symbol for sport, nature, space exploration, animal or other interests by incorporating an object exemplifying such interest into the connecting assembly. It would be desirable to provide an improved flexible connector for bands or bracelets.

### SUMMARY OF THE INVENTION

While many fasteners or clasps or hooks are available in bands or bracelets, there is a need for a flexible, easy to use and cost effective connector for bands or bracelets. Similarly, there is a compelling need that allows the wearer a prominent place to display a preferred object of passion or pursuit, or useful objects as disclosed herein. The present invention satisfies these unmet needs by providing novel designs that comprise a flexible connecting assembly that allows the wearer to readily utilize the connecting assembly, and an optional band or bracelet to form a wearable band or bracelet. The present invention also allows for ease of replacement, interchangeably of components and cost efficiency if and when the wearer wishes to have connecting assembly replaced, updated or exchanged. The connecting assembly may be used to carry or store personal and safety or security items. The following embodiments, aspects and variations thereof are exemplary, illustrative, and are not intended to be limiting in scope.

In one aspect of the invention, there is provided a connecting assembly for connecting a wearable band comprising at least one connector body, the connector body comprising a top face, a bottom face and a side; at least one linker, the linker comprising a proximal end and a distal end, the distal end comprising a protrusion (or a bulge); at least one slot, wherein the slot is configured on the connector body or configured on the linker; wherein the proximal end of the linker is connected to the connector body; wherein the slot on the connector body or on the linker is configured to accept the protrusion to reversibly connect the distal end of the linker to the connector body or to the slot on the linker; and wherein the linker and the connector body comprise silicone or a silicone composite. As disclosed herein, the invention provides a connecting assembly for connecting a linker with the connector body for forming a wearable band so that a protrusion and/or the slot may be designed and configured interchangeably either on the linker or the connector body.

In one aspect, there is provided a connecting assembly, wherein the connector body comprises of at least one, two, three or four slots for accepting a plurality of protrusions. As disclosed herein, the connection formed by the insertion of a protrusion into a slot forms a reversible connection that cannot be readily dislodged or disconnected under normal wearing conditions, but the connection may be disconnected by urging the protrusion back out from the flexible slot. In one aspect, the protrusion is formed such that the diameter or circumference of the protrusion is larger than the slot in which the protrusion may be inserted into, and the protrusion must be urged, forced, compressed or otherwise deformed to fit snugly into or through the slot so as not to be readily dislodged without force. Because the protrusion and the slot is a silicone or a silicone composite, both elements are flexible and deformable, and form a tight connection when linked together. At the same time, the connection is also reversibly disconnected by pulling on the linker and/or deformedly or compressibly pushing and urging the protrusion out of the slot.

In another aspect, there is provided a connecting assembly, wherein the connector body is substantially hollow or solid. In another aspect, there is provided a connecting assembly, wherein the connector body is substantially spherical or semi-spherical, substantially rectangular or semi-rectangular, or substantially oval or semi-oval. In one embodiment, the connector body is a dome or a half-dome. In another embodiment, the connector body further comprises a skirt that is attached to the connector body and radially projects from the connector body. In various embodiments of the above, the connector body may be hollow or solid.

In one aspect, there is provided a connecting assembly, wherein the connector body is substantially flat or planar. In another aspect, there is provided a connecting assembly, wherein the connector body is configured to accept a decal or an image; or where the connector body is configured to be molded (manufactured by extrusion, mold etc . . . ) in a surface texture for the particular object as disclosed herein. In one embodiment of the above, the connector body may be configured to accept printing comprising words or phrases or slogans. In another embodiment, the connector body may be configured to accept patterns, decaling, etching, engraving, debossing or embossing.

In another aspect, there is provided a connecting assembly, wherein the top face is convex and the bottom face is concave. In one embodiment of the above, the top face may be concave and the bottom face may be convex. In another embodiment, the top and bottom face both may be substantially flat. In one particular embodiment, the connector body the top face is concave and the bottom face is convex, wherein the top face further comprises a lip that is directed centripetally.

In one aspect, there is provided a connecting assembly, wherein the connector body is modeled as a sport accessory or equipment, and wherein the connector body is further configured with at least one, two, three or four slots for accepting a plurality of protrusions. In one variation, the connector body is configured with at least five, six, seven, eight or more slots. In one embodiment of the above, the connector body is selected from a group consisting of a basketball, a semi-basketball, a baseball bat, a tennis racquet and swimming goggles. In another embodiment, the connector body is a baseball, a golf ball, a soccer ball, a football, a volley ball, a tennis ball or any semi-ball thereof.

In another aspect, there is provided a connecting assembly, wherein the connector body is modeled as an animal or an insect, and wherein the connector body is further configured with at least one, two, three, or four slots for accepting a plurality of protrusions. In one embodiment of the above, the connector body is selected from a group consisting of a bird, a ladybug, a butterfly, a horse, a sea lion, a dolphin, a cat, a rabbit, a penguin and a dog.

In another aspect, there is provided a connecting assembly, wherein the connector body is modeled as a mechanical object, and wherein the connector body is further configured with at least one, two, three or four slots for accepting a plurality of protrusions. In one embodiment of the above, the connector body is further selected from a group consisting of flying and moving objects. In another embodiment, the connector body is configured to be selected from a group consisting of an aircraft, a sea vessel and a wheeled craft. In one embodiment, the connector body is configured to be selected from a group consisting of a jet, a helicopter, a ship, a bike, a motorbike, a car and a train.

In another aspect, there is provided a connecting assembly, wherein the connector body is configured to be adopted to be able to incorporate a symbol or display that may be selected from a group consisting of a logo, a mascot and a mark of an organization; and/or wherein the connector body is further configured with at least one, two, three or four slots for reversibly accepting a plurality of protrusions. In one embodiment of the above, the connector body is a symbol of a fraternity, a sorority or a school. In yet another embodiment, the connector body may be configured to display a logo of a company, such as Apple®, Facebook®, IBM®, GE®, Pfizer® or Coca-Cola®. In one embodiment, the logo or symbol is used for the advertisement or promotional purpose of the organization. In one embodiment, the connector body is a sacred symbol such as a religious figure, theme or symbol.

In another aspect, there is provided a connecting assembly, wherein the connector body is configured to further adopt or accept a mechanical or an electronic device, such as a security or communication device (e.g., a mini walkie talkie, mini cell phone), a wireless application device, an LED light, a tracking device (e.g., a GPS unit), a time piece and a light source, and wherein the connector body is further configured with at least one, two, three or four slots for accepting a plurality of protrusions. In one particular embodiment of the above, the connector body comprises a watch face.

In one aspect, there is provided a connecting assembly, wherein the connector body is modeled as a vegetable or a fruit (e.g., an apple, orange, cherry, strawberry etc . . . ), and wherein the connector body is further configured with at least one, two, three or four slots for accepting a plurality of protrusions. In one embodiment of the above, the connector body is configured to be able to adopt a form selected from a group consisting of a banana, an apple, a carrot and a tomato.

In one aspect, there is provided a connecting assembly, wherein the connector body is modeled as an astronomical object, and wherein the connector body is further configured with at least one, two, three or four slots for reversibly accepting a plurality of protrusions. In one embodiment of the above, the connector body is selected from a group consisting of a star, a planet, a comet, a star system and a galaxy.

In one variation of the above, there is provided a connecting assembly, wherein the connector body is configured to be able to adopt a form selected from a seashell, a skull and cross-bone, and wherein the connector body is further configured with at least one, two, three or four slots or more, for accepting a plurality of protrusions.

In one variation of the above, there is provided a connecting assembly, wherein the connector body is modeled as human organs or body parts, and wherein the connector body is further configured with at least one, two, three or four slots for accepting a plurality of protrusions. In one embodiment of the above, the connector body is selected from a group consisting of a heart, a hand and an arm.

In one variation of the above, there is provided a connecting assembly, wherein the connector body is configured to accept printing, embossing and patterning, and wherein the connector body is further configured with at least one, two, three or four slots for accepting a plurality of protrusions.

In one aspect, there is provided a connecting assembly, wherein the protrusion is substantially conical, spherical, rectangular, triangular, annular and oval, wherein the protrusion comprising a circumference or diameter substantially the same as or different from the circumference or diameter of the linker, and wherein the protrusion is substantially hollow or solid.

In another aspect, there is provided a connecting assembly, wherein the slot comprises a circumference or diameter that is smaller than the circumference or diameter of the protrusion; wherein at least one protrusion is readily urged through at least one slot to form a connection between a plurality of linkers and a plurality of connector bodies; and wherein the protrusion is not readily dislodged from the slot without the application of force that deforms the protrusion or the slot, or both. In one embodiment of the above, the slot is a through slot.

In one particular aspect, there is provided a linker comprising a proximal end and a distal end, the distal end comprising a protrusion, the proximal end comprising a slot, wherein the slot is configured to accept the protrusion. In one aspect, there is provided a linker, wherein the protrusion comprises a circumference or diameter that is at least equal to the circumference or diameter of the linker, and wherein the slot comprises a circumference or diameter that is smaller than the circumference or diameter of the protrusion and of the linker. In one embodiment, the protrusion comprises a circumference or diameter that is smaller or larger than the circumference or diameter of the linker, and wherein the slot comprises a circumference or diameter that is smaller or bigger than the circumference or diameter of the linker. In various embodiments, the slot comprises a circumference or diameter that is smaller than the circumference or diameter of the protrusion. In one embodiment of the above, the linker is silicone or silicone composite.

In one aspect of the invention, there is provided a wearable band comprising at least one connecting assembly, one linker, and a connecting band. In one embodiment of the above, the connecting band further comprising at least one connecting assembly, at least one linker, and a plurality of interconnected rings, wherein the ring is silicone or silicon composite or an elastomer.

In one aspect, there is provided a method of reversibly connecting at least one linker and at least one connector body of the connecting assembly comprising urging the protrusion through the slot on the connector body or through the slot on the linker, wherein the protrusion is not readily dislodged from the slot without the application of force that deforms the protrusion or the slot.

In one aspect, there is provided a method of reversibly connecting a plurality of linkers comprising urging the protrusion on the distal end through the slot on the proximal end, wherein the protrusion and the slot are on the same or different linker, and wherein the protrusion is not readily dislodged from the slot without the application of force that deforms the protrusion or the slot.

### BRIEF DESCRIPTION OF THE DRAWINGS

These and other features, aspects, and advantages of the present invention will become apparent from the following description, appended claims, and the accompanying exemplary embodiments shown in the drawings, which are briefly described below.

FIG. 1 is a top view of a linker according to one exemplary embodiment.

FIG. 2 is a top view according to one exemplary embodiment of a connecting assembly showing a connector body modeled as a heart with a skirt, a slot configured on the connector body and two linkers attached at the proximal end to the connector body, with a protrusion on the distal end of each linker.

FIG. 3 is a top view according to one exemplary embodiment of a connecting assembly showing a connector body modeled as a flat rectangular comprising a watch face, with multiple slots configured on the connector body and two linkers attached at the proximal end to the connector body, with a protrusion on the distal end of each linker.

FIG. 4 is a side view according to one exemplary embodiment of a wearable band comprising multiple connecting assemblies, showing the connector body modeled as a half-basketball.

FIG. 5 is a top view of a wearable band showing a connecting assembly according to one exemplary embodiment.

FIG. 6 is a top view of a connecting assembly according to an exemplary embodiment.

FIG. 7 is a bottom side view of a connecting assembly according to an exemplary embodiment.

FIG. 8 is a top view of a connecting assembly connected to elastic rings according to an exemplary embodiment.

### DETAILED DESCRIPTION OF THE PREFERRED EMBODIMENTS

The invention is described in more detail hereinafter with reference to exemplary embodiments. In the figures, the same reference numerals are used for similar components in different embodiments. It is understood that the invention is not limited in its application to the details of construction and the arrangement of components set forth in the following description or illustrated in the following drawings. The invention is capable of other embodiments and of being practiced or of being carried out in various ways. Also, it is understood that the phraseology and terminology used herein is for the purpose of description and should not be regarded as limiting.

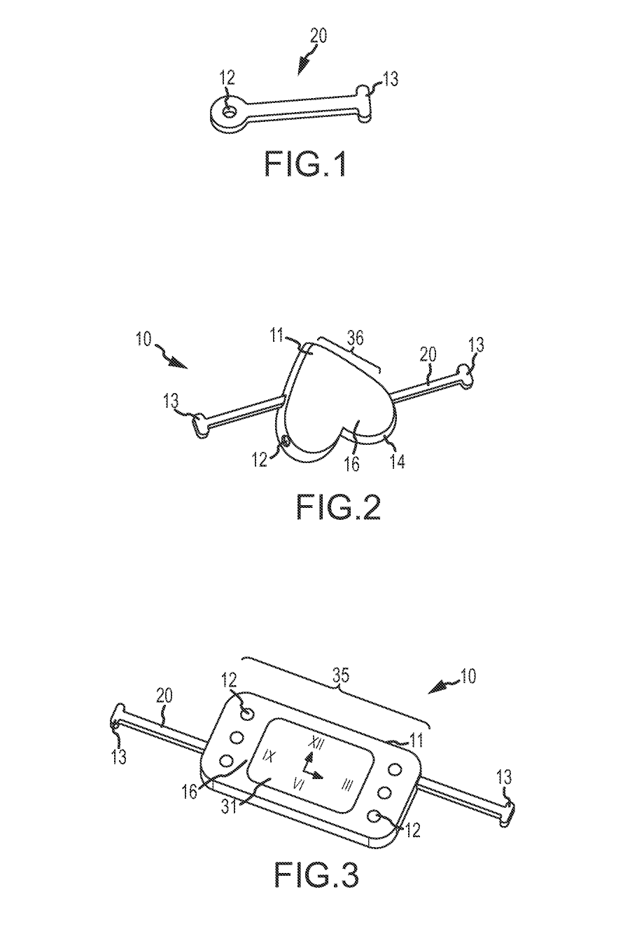

Referring to FIG. 1, a linker 20 is shown according to an exemplary embodiment. The linker 20 comprises a slot 12 and a protrusion 13.

Referring to FIG. 2, a connecting assembly 10 is shown according to an exemplary embodiment. The connecting assembly 10 comprises a connector body 11 with a top face 16 modeled as a heart 36 and a linker 20. In one embodiment, the connector body 11 comprises a skirt 14. A slot 12 is configured on the skirt 14 of the connector body 11. In one embodiment, the linker 20 comprises a protrusion 13 and is connected to the connector body 11 at the proximal end. The slot 12 is configured to accept the protrusion 13.

Referring to FIG. 3, a connecting assembly 10 is shown according to an exemplary embodiment. The connecting assembly 10 comprises a connector body 11 with a top face 16 and a linker 20. In one embodiment, the connector body 11 is a flat rectangle 35. In one embodiment, the linker 20 comprises a protrusion 13 and is connected to the connector body 11 at the proximal end. In one embodiment, a slot 12 is configured on the connector body 11 which also comprises a watch face 31.

Referring to FIG. 4, a wearable band 30 is shown according to an exemplary embodiment that comprises a plurality of the connecting assembly 10. In one embodiment, the connecting assembly 10 further comprises a connector body 11 modeled as a half-basketball 33 with a slot 12 configured on the connector body 11 and a linker 20. In one embodiment, the connector body 11 has a bottom face 15 and a top face 16. The linker 20 comprises a protrusion 13 which is urged through the slot 12. The protrusion 13 is illustrated in broken line to represent that the protrusion 13 is hidden from view.

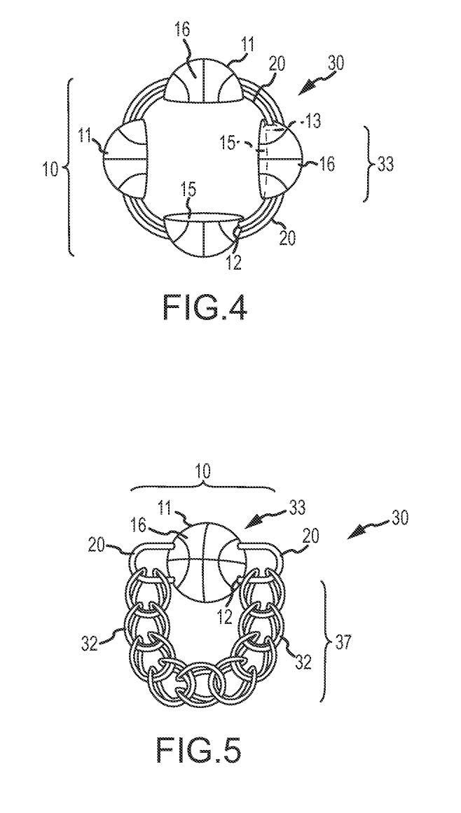

Referring to FIGS. 5 and 8, a wearable band 30 is shown according to an exemplary embodiment that comprises a connecting assembly 10 and a connecting band 37 which comprises a plurality of rings 32. In one embodiment, the connecting assembly 10 comprises a connector body 11 with a top face 16, a linker 20 and a skirt 14. In one embodiment, the connector body 11 is modeled as a half-basketball 33. In another embodiment, a slot 12 is configured on the connector body 11. In one embodiment, the slot 12 is configured on the skirt 14. The linker 20 comprises a protrusion 13, represented by broken line to represent that the protrusion 13 is hidden from view.

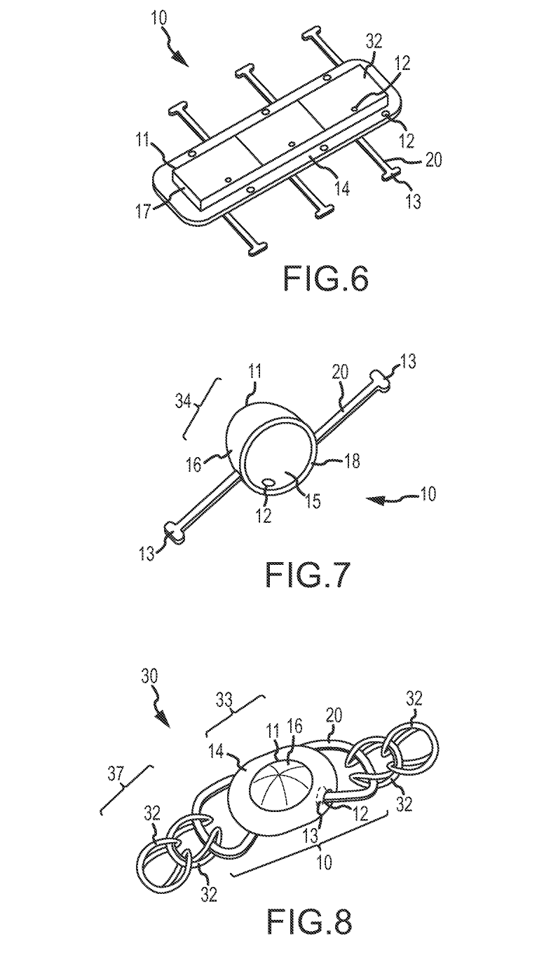

Referring to FIGS. 6 and 7, a connecting assembly 10 according to one exemplary embodiment is shown that comprises a connector body 11 with a bottom face 15 and a top face 16, and a linker 20. In one embodiment, the connector body 11 comprises a skirt 14. In another embodiment, the connector body 11 comprises a lip 18. In another embodiment, a slot 12 or a plurality of slots 12 is configured on the connector body 11 or the skirt 14. In various embodiments, the connector body 11 can be a pill box 32, a semi-sphere 34. In one embodiment, the linker 20 comprises a protrusion 13.

In one aspect of the invention, there is provided a connecting assembly 10 for connecting a wearable band 30 comprising at least one connector body 11, the connector body 11 comprising a top face 16, a bottom face 15 and a side 17; at least one linker 20, the linker 20 comprising a proximal end and a distal end, the distal end comprising a protrusion 13; at least one slot 12, wherein the slot 12 is configured on the connector body 11 or configured on the linker 12; wherein the proximal end of the linker 20 is connected to the connector body 11; wherein the slot 12 on the connector body 11 or on the linker 20 is configured to accept the protrusion 13 to connect the distal end of the linker 20 to the connector body 11 or to the slot 12 on the linker 20; and wherein the linker 20 and the connector body 11 comprise silicone or a silicone composite.

In various embodiments, the slot 12 and protrusion 13 can optionally be on axially opposite ends thereof. In one embodiment, the slot 12 is configured as an eye similar to an eye of a needle. In one aspect of the invention, the connecting assembly 10 comprises a composite of deformable or flexible elastomers. In another embodiment, the connecting assembly 10 comprises rubber. In one embodiment, the connecting assembly 10 is constructed from plastic or other elastic materials. In one embodiment, the connecting assembly 10 is constructed from leather. In another embodiment, the connector body 11 further comprises precious metals, gems stone, diamond or rare earth metals. In one embodiment, the connecting assembly 10 comprising a linker 20 and a connector body 11, wherein the connecting assembly 10 is a unitary construction of silicone or silicone composite constructed from a single mold and a single mold extrusion process.

In one aspect, there is provided a connecting assembly 10, wherein the connector body 11 comprises of at least one, two, three, or four slots 12 for accepting a plurality of protrusions 13. In one embodiment of the above, the connector body 11 further comprises at least five, six, or seven slots 12. In another aspect, there is provided a connecting assembly 10, wherein the connector body 11 is substantially hollow or solid.

In another aspect, there is provided a connecting assembly 10, wherein the connector body 11 is substantially spherical or semi-spherical, substantially rectangular or semi-rectangular, or substantially oval or semi-oval. In various embodiments of the above, the connector body 11 is conical, triangular, rhomboid or diamond shaped. In another embodiment, the connector body 11 is elongate or annular. In one embodiment, the connector body 11 is a dome or a half-dome 34. In another embodiment, the connector body 11 is a rectangle 35. In another embodiment, the connector body 11 further comprises a skirt 14 that is attached to the connector body 11 and radially projects from the connector body 11. In various embodiments of the above, the connector body 11 may be hollow or solid.

In one aspect, there is provided a connecting assembly 10, wherein the connector body 11 is substantially flat. In another aspect, there is provided a connecting assembly 10, wherein the connector body 11 is configured to accept a decal or an image. In one embodiment of the above, the connector body 11 may be configured to accept printing comprising words or phrases or slogans. In another embodiment, the connector body 11 may be configured to accept patterns, or etching, engraving, debossing or embossing.

In another aspect, there is provided a connecting assembly 10, wherein the top face 16 is convex and the bottom face 15 is concave. In one embodiment of the above, the top face 16 may be concave and the bottom face may be convex. In another embodiment, the top face 16 and the bottom face 15 both may be substantially flat. In one particular embodiment, the top face 16 is concave and the bottom face 15 is convex, wherein the top face 16 further comprises a lip 18 that is directed centripetally.

In one aspect, there is provided a connecting assembly 10, wherein the connector body 11 is modeled as a sport accessory or equipment. In one embodiment of the above, the connector body 11 is selected from a group consisting of a basketball, a semi-basketball 33, a baseball bat, a tennis racquet and swimming goggles. In another embodiment, the connector body 11 is a base ball, a golf ball, a soccer ball, a football, a volley ball, a tennis ball or any semi-ball thereof. In yet another embodiment, the connector body 11 is selected from a group consisting of sport racquet such as a ping pong racquet, a squash racquet and a badminton racquet. In one embodiment, the connector body 11 is selected from a group consisting of baseball, football, and basketball equipment or accessory such as a baseball cap, a football helmet, a basketball backboard and a baseball plate. In another embodiment, the connector body 11 is selected from a group consisting of hockey equipment such as a puck and a hockey stick. In one embodiment, the connector body 11 is selected from a group consisting of a skateboard, a discus, a ski goggles and a snowboard. In another embodiment, the connector body 11 is selected from a group consisting of gymnastic equipment such as a gymnastic ring, a vaulting horse and a pommel horse. In other embodiment, the connector body 11 is selected from a group consisting of aquatic and water sport equipment such as diving and swimming gears. In one embodiment, the connector body 11 is selected from a group consisting of a snorkel, a fin, a floatation device, rowing, kayaking and river rafting equipment. In one embodiment, the connector body 11 is selected from a group consisting of sailboat, a sailboard and a kite board.

In another aspect, there is provided a connecting assembly 10, wherein the connector body 11 is modeled as an animal or an insect. In one embodiment of the above, the connector body 11 is selected from a group consisting of a bird, a ladybug, a butterfly, a horse, a sea lion, a dolphin, a cat, a rabbit, a penguin and a dog. In one embodiment, the connector body 11 is selected from a group consisting of aquatic or land animal and insect. In another embodiment, the connector body 11 is selected from a group consisting of insect such as a caterpillar, a honeybee, a millipede, a dragon fly, a crustacean, a fish and an echinoderm such as a starfish. In another embodiment, the connector body 11 is selected from a group consisting of domesticated animals such as pig and cow. In another embodiment, the connector body 11 is selected from a group consisting of wild animals such as a deer, a boar, a bear, a lion, a giraffe, a zebra and a hippo. In another embodiment, the connector body 11 is selected from a group consisting of flight bird such as a falcon, a hawk, an eagle, a parrot, a crane, owl, a hummingbird, a dove and a flamingo. In another aspect, there is provided a connecting assembly 10, wherein the connector body 11 is modeled as a mechanical object. In one embodiment of the above, the connector body 11 is further selected from a group consisting of flying and moving object. In another embodiment, the connector body 11 is selected from a group consisting of an aircraft, a sea vessel and a wheeled craft. In one embodiment, the connector body 11 is selected from a group consisting of a jet, a helicopter, a ship, a bike, a motorbike, a car and a train. In one embodiment, the connector body 11 is selected from a group consisting of a hot air balloon, a kite, a glider, a rocket or spacecraft and a parachute.

In another aspect, there is provided a connecting assembly 10, wherein the connector body 11 is selected from a group consisting of a logo, a mascot and a mark of an organization. In one embodiment of the above, the connector body 11 is a symbol of a fraternity, a sorority, or a school. In another embodiment, the connector body 11 is a mascot of a sport team or a school team. In yet another embodiment, the connector body 11 is a logo of a company such as Apple®, Facebook®, IBM®, GE®, Pfizer® or Coca-Cola®. In one embodiment, the connector body 11 is a sacred symbol such as a religious figure, theme, or symbol. In another aspect, there is provided a connecting assembly 10, wherein the connector body 11 further comprising a safety feature, a time piece and a light source. In one particular embodiment of the above, the connector body 11 comprises a watch face 31. In another embodiment, the connector body 11 comprises a GPS tracking device, a communication device or LED lights. In one embodiment, the connector body 11 comprises an electronic device selected from a group consisting of a panic alarm, a tracking device, a mini walkie talkie, a reflective material and a light source such as a flashing light. In another embodiment, the connector body 11 comprises a counter. In various aspects, the connector body 11 further comprises other suitable electronic devices for daily usage, such as wireless application devices.

In one aspect, there is provided a connecting assembly 10, wherein the connector body 11 is modeled as a vegetable or a fruit. In one embodiment of the above, the connector body 11 is selected from a group consisting of a banana, an apple, a carrot and a tomato. In one aspect, there is provided a connecting assembly 10, wherein the connector body 11 is modeled as an astronomical object. In one embodiment of the above, the connector body 11 is selected from a group consisting of a star, a planet, a comet, a star system and a galaxy. In one aspect, there is provided a connecting assembly 10, wherein the connector body 11 is modeled as a seashell, a skull and cross-bone.

In one aspect, there is provided a connecting assembly 10, wherein the connector body 11 is modeled as human organs or body parts. In one embodiment of the above, the connector body 11 is selected from a group consisting of a heart 36, a hand and an arm. In one embodiment, the connector body 11 is selected from a group consisting of cross-linking arms, shaking hands and two or more hearts attached to one another, wherein the hearts 36 are partly superimposed on each other. In various aspects, the connector body 11 serves the wearer's daily needs including medical, safekeeping or storage. In one embodiment, the connector body 11 is selected from a group consisting of a pill box 32, an eraser box and a memory box for storing keepsakes.

In one aspect, there is provided a connecting assembly 10, wherein the connector body 11 is configured to accept printing, embossing, debossing and patterning. In one aspect, there is provided a connecting assembly 10, wherein the protrusion 13 is substantially conical, spherical, rectangular, triangular, annular and oval, wherein the protrusion 13 comprising a circumference or diameter at least equal to the circumference or diameter of the linker 20, and wherein the protrusion 13 is substantially hollow or solid.

In another aspect, there is provided a connecting assembly 10, wherein the slot 12 comprises a circumference or diameter that is smaller than the circumference or diameter of the protrusion 13 and of the linker 20; wherein at least one protrusion 13 is urged through at least one slot 12 to form a connection between a plurality of linkers 20 and a plurality of connector bodies 11; and wherein the protrusion 13 is not readily dislodged from the slot 12 under normal wearing condition. In one embodiment of the above, the slot 12 is a through slot.

In one particular aspect, there is provided a linker 20 comprising a proximal end and a distal end, the distal end comprising a protrusion 13, the proximal end comprising a slot 12, wherein the slot 12 is configured to accept the protrusion 13. In one aspect, there is provided a linker 20, wherein the protrusion 13 comprises a circumference or diameter that is at least equal to the circumference or diameter of the linker 20, and wherein the slot 12 comprises a circumference or diameter that is smaller than the circumference or diameter of the protrusion 13 and of the linker 20. In one embodiment of the above, the linker 20 comprises of material selected from silicone or silicone composite.

In one aspect of the invention, there is provided a wearable band 30 comprising at least one connecting assembly 10, one linker 20, and a connecting band 37. In one embodiment of the above, the connecting band 37 further comprises at least one connecting assembly 10 and at least one linker 20.

In one aspect, there is provided a method of connecting at least one linker 20 and at least one connector body 11 of the connecting assembly 10 to form a reversible connection to form a wearable band 30 comprising urging the protrusion 13 through the slot 12 on the connector body 11 or through the slot 12 on the linker 20, wherein the protrusion 13 is not dislodged from the slot 12 under normal wearing conditions.

In one aspect, there is provided a method of connecting a plurality of linkers 20 to form a reversible connection to form a wearable band 30 comprising urging the protrusion 13 on the distal end through the slot 12 on the proximal end, wherein the protrusion 13 and the slot 12 are on the same or different linker 20, and wherein the protrusion 13 is not dislodged from the slot 12 under normal wearing condition. In one variation of each of the above embodiments, the connector body 11 further comprises at least five, six, seven or more slots.

### DEFINITIONS

The term “astronomical object” as used herein refers to celestial bodies or objects that are structures that exist in the observable universe. Examples include the asteroids, moons, planets and the stars, and galaxies.

The term “concave” as used herein refers to curving in or down or hollowed inward or downward.

The term “convex” as used herein refers to curving out or up or bulging outward or upward.

The term “centripetal” as used herein refers to direction or projection that is progressing inward toward the center or central axis of the connector body.

The term “connecting band” as used herein refers the closeable part of the wearable band that connects with the connecting assembly to form the wearable band.

The term “composite” as in “silicone composite” as used herein refers to engineered or naturally occurring materials comprising silicone and one or more constituent materials, with significantly different physical or chemical properties. Silicone composite may comprise fillers to improve properties or reduce cost. Silicone composite is generally strong and flexible, non-reactive, water-proof, stable and resistant to extreme conditions and temperatures.

The term “connecting assembly” as used herein refers to a flexible assembly that connects an optional closeable connecting band or bracelet to form a wearable band or bracelet. The wearable band or bracelet may be worn on a person or an animal's hand, finger, ear, head, arm, leg, neck and ankle or other body parts. Because such connecting assembly is substantially a removable band, the band may also be configured to attach to or on any objects, such as a bicycle or a part of a bicycle, car steering wheel, a cell phone, a PDA, a portable computer pad (e.g., an i-Pad) a water bottle, a post, a backpack or parts of a backpack, etc . . . As disclosed herein, the connecting assembly comprises a connector body and a linker.

The term “connector body” as used herein refers to a structure of the connecting assembly that has various shapes including spherical, semi-spherical, dome or half-dome, flat disc, or rectangular, or any shape thereof further attached to a skirt or a lip. The connector body can be solid or hollow.

The term “craft” or “vessel” as used herein refer to a vehicle or watercraft or vessel that is used for transportation on the sea, in the air or in space.

The term “dislodging” or “dislodged” as used herein mean that the protrusion cannot be readily disconnected or decoupled from the slot after being urged through or accepted into the slot under normal wearing conditions.

The term “elastomer” as used herein refers to a polymer with elasticity.

The term “elastic” as used herein refers to the ability of a material such as silicon or rubber to be stretched and to revert to substantially the original form. Elastic deformation is a substantially reversible deformation of a material.

The term “lip” as used herein refers to the lip structure attached to the connector body and which projects centripetally toward the center of the connector body.

The term “linker” as used herein refers to one or more line-like element that comprises a protrusion and a slot and that connects one or a plurality of connector bodies or a plurality of similarly configured linkers together to form a band or a bracelet with fixed or adjustable size or length.

The term “mechanical object” as used herein refers to object that is a machine, operated by a machine, or derived from a machine.

The term “mold”, “molding” or “molded” as used herein refers to a process of manufacturing by shaping pliable or elastic materials using a model such that the article of manufacture adopts an appearance substantially similar to the model.

The term “organization” as used herein refers to an entity which can be public or private, non- or for-profit, religious or denominational. The organization may be a company, a religious body, a sport team, a school, a civic organization, or a common purpose association.

The term “protrusion” as used herein refers to a protruded structure or a bulge on either a linker or a connector body that may be urged through or accepted into a slot to establish a reversible connection or reversible attachment between linkers and connector bodies or combinations thereof. Such protruded structure may encompass various symmetrical or unsymmetrical or multi-faceted configurations.

The term “ring” as used herein will be understood to mean a continuous-loop object, it being understood that the term “ring” shall not be limited to an annular, toroidal shape. Also, while certain rings may be illustrated herein with round cross-sections, such cross-section can be any shape, and may have a thickness that is solid or hollow, tubular. In addition, such rings may be any size and are of any elastic material.

The term “skirt” refers to the (planet) Saturn-ring like structure attached to the connector body and which projects radially from the center of the connector body.

The term “through slot” as used herein refers to a slot that opens on both faces of the connector body.

The term “slot” as used herein refers to a narrow opening on a linker or a connector body. The slot may comprise a through opening or an air hole (a “through slot”) where the protrusion may be urged completely through. The slot may also be configured not to be a through opening, capable of accepting or receiving the protrusion, while preventing the protrusion from being dislodged easily under normal daily wearing condition and without the application of force to the slot or the protrusion.

The term “semi-sphere” as used herein refers to one half of a sphere. The sphere may be hollow spheres, semi-hollow spheres or filled spheres. In certain aspects, the hollow or semi-hollow spheres may further comprise a lip for retaining an insert or object as disclosed herein.

It will be apparent to those skilled in the art that various modifications and variations can be made to the flexible wearable band, connecting assembly, connector body, linker and methods of the present invention without departing from the spirit or scope of the invention. Thus, it is intended that the present invention cover the modifications and variations of this invention provided they come within the scope of the appended claims and their equivalents.

What is claimed is:

1. A connecting assembly for connecting a wearable band comprising:
at least one connector body, the connector body comprising a top face, a bottom face and a side;
at least one linker, the linker comprising a proximal end and a distal end, wherein the distal end comprises a protrusion;
at least one slot, wherein the slot is configured on the connector body or configured on the linker;
wherein the proximal end of the linker is connected to the connector body;
wherein the slot on the connector body or on the linker is configured to accept the protrusion to reversibly connect the distal end of the linker to the slot on the connector body or to the slot on the linker; and
wherein the linker and the connector body comprise of material selected from silicone or a silicone composite.

2. The connecting assembly of claim 1, wherein the connector body comprises of at least one, two, three or four slots for accepting a plurality of protrusions.

3. (canceled)

4. The connecting assembly of claim 1, wherein the connector body is substantially spherical or semi-spherical, substantially rectangular or semi-rectangular, or substantially oval or semi-oval.

5-6. (canceled)

7. The connecting assembly of claim 1, wherein the top face is convex and the bottom face is concave.

8. The connecting assembly of claim 1, wherein the connector body is modeled as a sport accessory or equipment.

9. The connector body of claim 8, wherein connector body is selected from a group consisting of a basketball, a semi-basketball, a baseball, a football, a baseball bat, a tennis ball, a tennis racquet, a soccer ball and swimming goggles.

10. The connecting assembly of claim 1, wherein the connector body is modeled as an animal or an insect.

11-12. (canceled)

13. The connecting assembly of claim 1, wherein the connector body is further selected from a group consisting of a flying and a moving object.

14-15. (canceled)

16. The connecting assembly of claim 1, wherein the connector body is selected from a group consisting of a logo, a mascot and a mark of an organization.

17. The connecting assembly of claim 1, wherein the connector body further comprising a safety feature, object or device, a time piece and a light source.

18-24. (canceled)

25. The connecting assembly of claim 1, wherein the connector body is selected from a group consisting of a heart, a hand and an arm.

26. The connecting assembly of claim 1, wherein the connector body is configured to accept printing, decaling, embossing and patterning.

27. The connecting assembly of claim 1, wherein the protrusion is substantially conical, spherical, rectangular, triangular, annular and oval, and wherein the protrusion comprises a circumference or diameter substantially the same as or different from the circumference or diameter of the linker, and wherein the protrusion is substantially hollow or solid.

28. The connecting assembly of claim 27;
wherein the slot comprises a circumference or diameter that is smaller than the circumference or diameter of the protrusion;
wherein at least one protrusion is urged through at least one slot to form a reversible connection between a plurality of linkers and a plurality of connector bodies; and
wherein the protrusion is not dislodged from the slot under normal wearing condition.

29. The slot of claim 28, wherein the slot is a through slot.

30. A linker comprising a proximal end and a distal end, the distal end comprising a protrusion, the proximal end comprising a slot, wherein the slot is configured to accept the protrusion.

31. The linker of claim 30, wherein the protrusion comprises a circumference or diameter that is substantially the same as or different from the circumference or diameter of the linker, and wherein the slot comprises a circumference or diameter that is smaller than the circumference or diameter of the protrusion.

32. The linker of claim 30, wherein the linker comprises of material selected from silicone or silicone composite.

33. A wearable band comprising at least one connecting assembly of claim 1, one linker of claim 32, and a connecting band.

34. The connecting band of claim 33 comprising at least one connecting assembly of claim 1, at least one linker of claim 32 and a plurality of interconnected rings, wherein the ring comprises material selected from silicone, silicon composite or an elastomer.

35-36. (canceled)
